(19) United States
(12) Patent Application Publication
(10) Pub. No.: US 2016/0183751 A1
(43) Pub. Date: Jun. 30, 2016

(54) Vacuum Cleaner Filter Bag Having a Spacing Element

(71) Applicant: EUROFILTERS N.V., Overpelt (BE)

(72) Inventors: Ralf SAUER, Overpelt (BE); Jan SCHULTINK, Overpelt (BE)

(73) Assignee: Eurofilters Holding N.V., Overpelt (BE)

(21) Appl. No.: 14/910,914

(22) PCT Filed: Aug. 8, 2014
(86) PCT No.: PCT/EP2014/067047

§ 371 Date: Feb. 8, 2016

(30) Foreign Application Priority Data
Aug. 9, 2013 (EP) 13179947.0

(51) Int. Cl. A47L 9/14; B01D 46/02

(52) U.S. Cl. CPC A47L 9/14; B01D 46/02

(57) ABSTRACT

The present invention relates to a vacuum cleaner filter bag made of nonwoven fabric which has a joint of the nonwoven fabric layers which seals the bag at the side at least at one place. At at least one place of the edge, a spacing means, which is configured by a double weld seam or reinforcing elements which are fitted in this region, is thereby included. A characterising feature of the vacuum cleaner filter bag according to the present invention is an increased three-point bending strength.

The present invention relates to a vacuum cleaner filter bag made of nonwoven fabric which has a joint of the nonwoven fabric layers which seals the bag at the side at least at one place. At at least one place of the edge, a spacing means, which is configured by a double weld seam or reinforcing elements which are fitted in this region, is thereby included. A characterising feature of the vacuum cleaner filter bag according to the present invention is a three-point bending strength which is specifically increased in one region of the vacuum cleaner filter bag.

A substantial aim in the development of vacuum cleaner filter bags made of nonwoven fabrics is to use the constructional space available in the vacuum cleaner as completely as possible. Several aspects must thereby be taken into account. The filter bag should be unfolded and assume such a shape such that the available constructional space is filled as completely as possible. On the other hand, a free space must however be maintained around the filter bag via which the cleaned air can flow away with as low a resistance as possible. On the vacuum cleaner side, ribs are provided in the appliance for this purpose, which are intended to prevent the filter bag from abutting against the walls. A specially troublesome region is the suction opening of the motor fan unit in one of the walls forming the filter bag receiving space. A motor protection filter which is fixed in front of the suction opening via a grid-shaped mounting is situated in front of this opening.

If the filter bag settles in front of this opening, the air flows mainly through the partial surface area of the filter bag which lies directly in front of the suction opening.

This partial surface area then becomes clogged overproportionally, which leads to a rapid increase in pressure loss. At the same time, only a reduced low pressure is achieved in the filter bag receiving space. The suction power of the vacuum cleaner becomes correspondingly less. As a result of the fact that it is intended to be possible to use a filter bag model in different vacuum cleaner models, the design of a filter bag model is further complicated. The shaping of the ribbing of the constructional space, size and proportions of the filter bag receiving space and the position of the suction opening of the motor fan unit and also the position of the retaining plate receiving means often differ considerably.

Very soft nonwoven fabrics offer the advantage of easier unfolding of the filter bag than hard and rigid nonwoven fabrics. On the other hand, the danger exists with these materials that the nonwoven fabric settles easily between the ribs and thus the air is prevented from flowing away.

In order to solve these problems, various solution approaches which are all designed on the appliance side are known from the state of the art.

Thus EP 2 465 399 A2 describes an additional cage which is introduced into the filter bag receiving space and keeps the filter bag at a spacing from the walls of the filter bag receiving space.

EP 2 236 070 A2 relates to a special arched rib structure in front of the motor protection filter.

EP 2 326 227 B1 describes an insertion part for the filter receiving space with flow-conducting ribs.

However it is always disadvantageous with these solution approaches on the appliance side that the space available for the filter bag turns out to be smaller due to the additional means and hence the dust storage capacity or the dust receiving means of a corresponding vacuum cleaner model turns out to be less than the theoretical maximum.

Starting herefrom, it is the object of the present invention to provide a filter bag which solves the above-mentioned problems. It is intended to be ensured that the outflow of air from the filter bag receiving space is impaired as little as possible by the filter bag abutting against the inside of the filter bag receiving space or against the suction opening. It is intended hereby to be avoided that the volume of a filter bag is excessively restricted and also that no appliance-side pressure drops result even with fairly long operation. This object is achieved according to a vacuum cleaner filter bag having the features of patent claim 1. The dependent patent claims thereby represent advantageous developments.

According to the invention, a vacuum cleaner filter bag made of nonwoven fabric is hence indicated, the nonwoven fabric having a joint which seals the bag at at least one edge of the vacuum cleaner filter bag and in the case of which at least two layers of nonwoven fabric are joined to each other, the vacuum cleaner filter bag comprising, at least at one place of the edge, a spacing means which is formed by at least one further joint of the two layers of the nonwoven fabrics being configured in the region of the joint which seals the bag and/or at least one reinforcing element being fixed on at least one of the two layers of nonwoven fabric or between the two layers of nonwoven fabric, the three-point bending strength Fₘₐₓ of a test piece of the vacuum cleaner filter bag, measured according to DIN 53 121 with a path stretch of 7 mm, being at least 2.0 N.

The solution according to the invention hence provides that at least one edge-side region of the vacuum cleaner filter bag, which is formed by at least two layers of nonwoven fabric being joined to each other and hence a joint which seals the vacuum cleaner filter bag being present, is reinforced. This is effected according to the invention by at least one further joint of the two layers of nonwoven fabric being configured in the region of the sealing joint and/or at least one reinforcing element being fixed on at least one of the two layers of nonwoven fabric or between the two layers of nonwoven fabric. The increased rigidity is determined, by means of the three-point bending strength Fₘₐₓ of a test piece of a vacuum cleaner filter bag, according to DIN 53 121 with a path stretch of 7 mm. According to the invention, the three-point bending strength F, is at least 2.0 N.

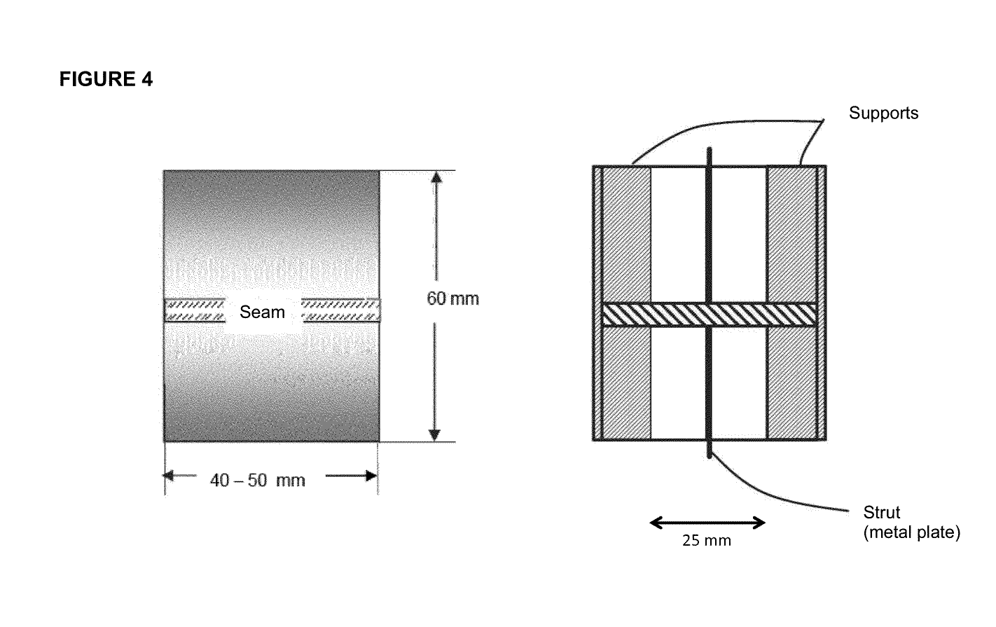

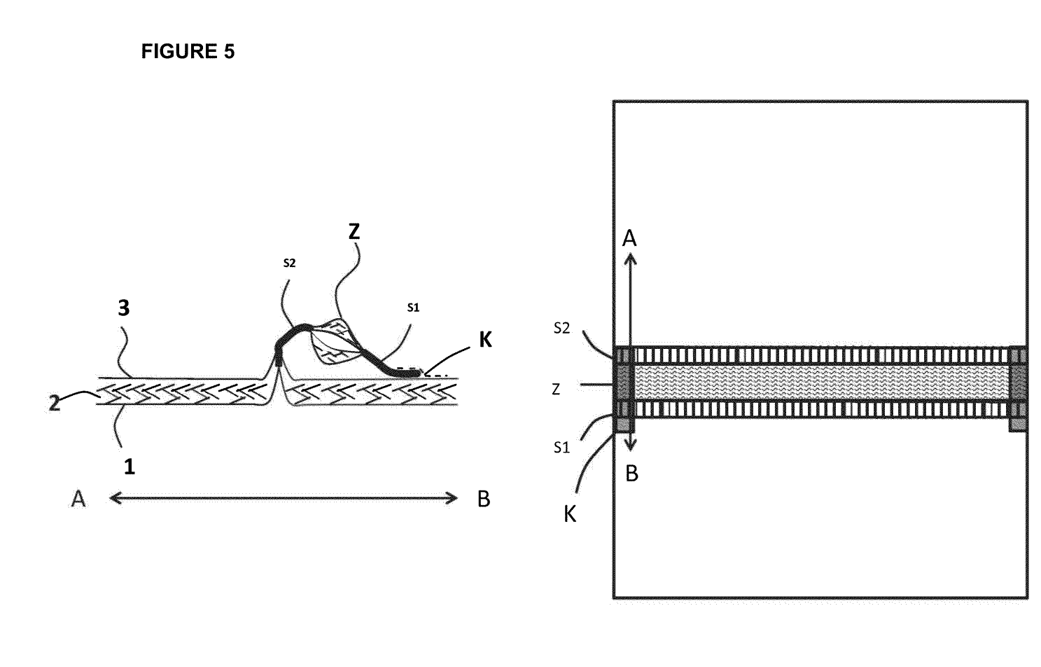

As test piece, a blank of a vacuum cleaner filter bag according to the invention which is cut to size as illustrated in FIG. 4 is thereby used. FIG. 4 thereby shows a plan view on a 60 mm, dimensioned to 40-50 mm blank, the “seam” denoted in FIG. 4 illustrating a view on the upright edge-side joint. In order to prevent the upright position of the seam of the test result being affected, it is fixed on both sides of the sample by means of adhesive tape (Tesa Film) such that the weld seam lies flat on the nonwoven fabric. This embodiment is illustrated in more detail on the right-hand side in FIG. 5.

The precise construction both of the filter bag according to the invention and also of the test piece is explained in detail with reference to the accompanying description of the Figures.

For the tests, the method for determining the three-point bending strength according to DIN 53 121 was used and adapted. For this purpose, the lower part of a 3-point bending strength testing device according to DIN 53 121 was incorporated in a universal-tension-pressure testing machine. In the upper retaining clamp, a metal plate with a rounded lower edge (strut) and a thickness of 2 mm was incorporated. The sample to be tested was placed on the supports in the testing device lower part such that the seam to be tested was orientated at a 90° angle to the metal plate. This arrangement is illustrated on the right-hand side of FIG. 4. The sample was not fixed in the testing device.

The test pieces for the tests were prepared and tested at room temperature of 23° C. and acclimatised at 50% relative air humidity.

The subsequent pressure test was effected under the conditions mentioned below.

Testing device: Universal strength machine TIRA 2805

Measuring quantity: 10 kN

Initial force: 0.1 N

Path: 7 mm

Test speed: 12.5 mm/min

Strut thickness: 2 mm

Spacing between the

supports: 25 mm

Number of measurements: 5

After reaching the initial force of 0.1 N, the strut in the upper testing device part was pressed towards the seam over a path of 7 mm and a corresponding force-path diagram was recorded.

In order to characterise the seam strength, the maximum resistance force of the seam, which the latter was subjected to by a pressure deformation of 7 mm, was measured. The result is indicated as maximum force Fₘₐₓ in N and defined as three-point bending strength.

Surprisingly, it was able to be established that the increased rigidity of the spacing element which is provided according to the invention on the vacuum cleaner filter bag is sufficient to solve the initially described problems. In particular, the vacuum cleaner filter bag can thereby be effectively prevented from being suctioned into the suction opening of the motor fan unit during operation of a vacuum cleaner and from sealing the latter so that impeding the outflow in the region of the suction opening of the motor fan unit can be prevented.

The previously mentioned reinforcing element, e.g. a material strip, can be formed from a material which is rigid compared with the nonwoven fabric, e.g. a cardboard or plastic material strip.

According to a preferred embodiment, the three-point bending strength Fₘₐₓ of the test piece is at least 3 N, preferably at least 5 N, particularly preferably at least 7 N.

The vacuum cleaner filter bag according to the invention is not restricted to any specific shape. In particular, the vacuum cleaner filter bag according to the invention can be configured in the form of a flat bag or side-gusseted bag and can comprise a first layer of a nonwoven fabric which has the inlet opening (E), and also a second layer of an air-permeable nonwoven fabric, the two layers of the nonwoven fabric being joined to each other continuously at the edge-side, as a result of which the two layers of the nonwoven fabric form a sealed bag. In the case of a side-gusseted bag, the two nonwoven fabric layers are folded onto opposite sides and are welded together via the other sides.

An alternative embodiment provides that the vacuum cleaner filter bag is configured as a 3D bag, pleated vacuum cleaner filter bag or block bottom bag. Such filter bags are known from example from EP 2 445 382 A1, EP 2 226 450 A1, DE 20 2005 016 309 U1 or EP 2 336 319 A1. With respect to the special geometric designs of the vacuum cleaner bag, reference is made in addition to these applications, the disclosure content of which can be used also for the purposes of the present invention.

Furthermore, it is advantageous if the at least one further joint is configured at a spacing relative to the sealing joint or abutting directly against the sealing joint.

It is preferred that the at least one further joint is disposed parallel or to the sealing joint (S1). However, also a non-parallel arrangement, e.g. an angled arrangement of the further joint relative to the sealing joint or even an undulating design of the at least one further joint is likewise possible.

A further preferred embodiment provides that the at least one further joint has a smaller length than the sealing joint, i.e. the at least one further joint does not extend over the entire filter bag width.

Furthermore, it is thereby advantageous if the at least one further joint extends at a spacing of 1 to 50 mm, preferably 3 to 25 mm, further preferably 5 to 15 mm, relative to the sealing joint.

The spacing means can comprise, in addition to the sealing joint, at least two further joints of the two layers of the nonwoven fabric which are configured respectively in the region for the sealing joint.

The at least two further joints can likewise be respectively at a spacing relative to each other and at a spacing relative to the sealing joint, furthermore it is possible that a first of the at least two further joints abuts directly against the sealing joint and the at least one further of the at least two further joints are at a spacing respectively relative to each other. In addition, it can be provided that both further joints abut against each other and the first of the further joints abuts against the sealing joint.

Furthermore, it is advantageous if the spacing of the at least two further joints relative to each other and/or the spacing of the first of the at least two further joints relative to the sealing joint is, independently of each other, from 1 to 50 mm, preferably 3 to 25 mm, further preferably 5 to 15 mm.

Any joint present, i.e. sealing joint, and also first or further joint can thereby have, independently of each other, a width of 1-50 mm, preferably 2-25 mm, particularly preferably 3-10 mm. For particular preference, all of the joints are chosen to have the same width.

A further advantageous embodiment provides that the at least one further joint is configured continuously over its length.

In particular, the at least one further joint is configured parallel to the sealing joint.

Preferably, the region (intermediate region) of the two layers of the nonwoven fabric, which is configured between the sealing joint and the at least one further joint disposed at a spacing relative thereto and/or the further joint disposed between respectively at least two, at a spacing relative to each other, is not joined or has joints of the two layers of the nonwoven fabric only in regions. These joints in the intermediate region can have for example a punctiform, star-shaped, cruciate or bar-shaped configuration. It is hereby particularly preferred that the joints are present in the intermediate region of the two layers of the nonwoven fabric, the joints having an oblong configuration and extending perpendicular to the sealing joint or to the at least one further joint or having a punctiform configuration.

Furthermore, it is advantageous if, in projection of the first towards the second layer of the nonwoven fabric, the contour of the vacuum cleaner filter bag has a polygonal configuration, in particular a rectangular configuration, and the spacing means is configured continuously over at least one side of the polygon, in particular of the rectangle.

The spacing means is configured in particular in the region of a suction opening of the motor fan unit of a vacuum cleaner which is suitable for the vacuum cleaner filter bag.

According to a further preferred embodiment, it can be provided that, on the first and/or second layer of the nonwoven fabric, at least one additional spacing means is configured, which is formed by joining, in places, regions of the respective layer of the nonwoven fabric which are folded one above the other. By means of this embodiment, a spacing can be achieved in a further region of the constructional space provided in a vacuum cleaner for the vacuum cleaner filter bag so that a further improvement in the air flow within the vacuum cleaner filter bag space of the vacuum cleaner is possible.

The sealing joint and/or the at least one further joint can be produced in particular by welding or by glueing together the two layers of the nonwoven fabric.

Furthermore, it is preferred if the nonwoven fabric comprises at least three filter material layers, at least one layer of which is a nonwoven fabric layer or a scrim layer and at least one layer is a fibre nonwoven layer, comprising staple fibres and/or filaments. Such filter materials are known for example from EP 1 795 247 and EP 1 960 084, and also from the European patent application with the application number EP13179851.4. With respect to the construction of the multilayer nonwoven material which can be used also for the subject of the present invention, reference is made in its entirety of content to the previously mentioned patent application. In particular in the case where the nonwoven material of the vacuum cleaner filter bag, according to the previously mentioned embodiment, has relatively few joints of the fibre nonwoven layer relative to the at least one further nonwoven fabric layer or scrim layer, it is advantageous that the nonwoven fabric, in or into the region or regions which are subjected directly to a flow by an air flow entering through the inlet opening into the interior of the filter bag, has a joint in the case of which the at least one fibre nonwoven fabric layer is joined to at least one of the at least two further layers so that a permanent fixing of the staple fibres and/or filaments of the fibre nonwoven layer to the at least one of the at least two further layers is ensured. With respect to this embodiment, reference is made to the European patent application with the application number EP 13179851.4.

Alternatively or additionally hereto, it can be provided that at least one diffuser is disposed in the interior of the vacuum cleaner filter bag between the first and the second layer of the nonwoven fabric. With respect to such diffusion, reference is made to the European patent applications EP 2 442 702 and EP 2 442 703, the disclosure content of which can be used also for the subject of the present invention with respect to the diffusers.

If necessary, a retaining plate can be fitted at the inlet opening. In particular a retaining plate as is known from the European patent application EP 2 606 799 is suitable for this purpose.

The present invention is explained in more detail with reference to the subsequent description without restricting the invention to the illustrated embodiments or Figures.

There are thereby shown

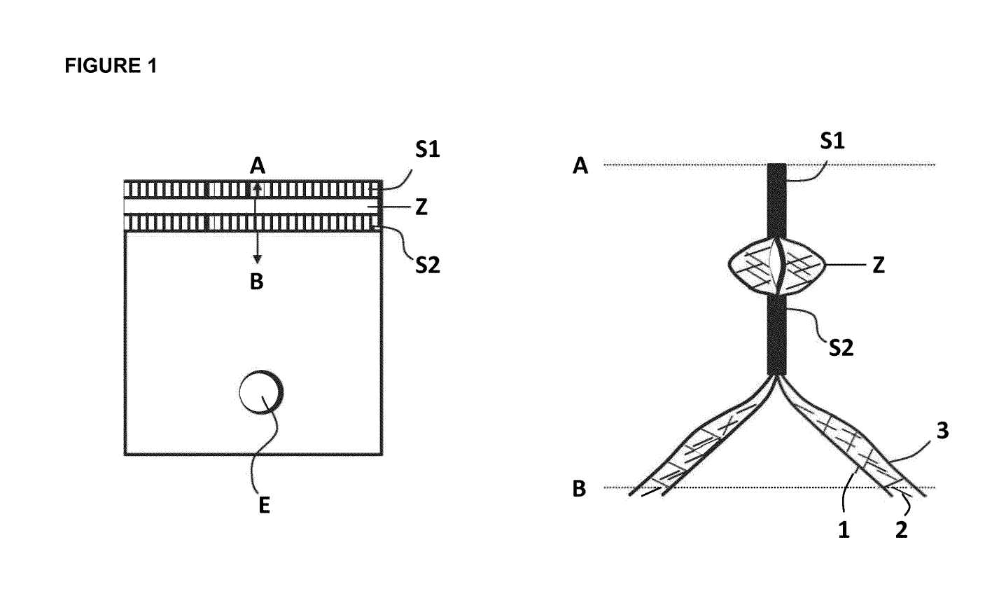

FIG. 1 a first embodiment of a vacuum cleaner filter bag according to the invention in plan view and cross-section.

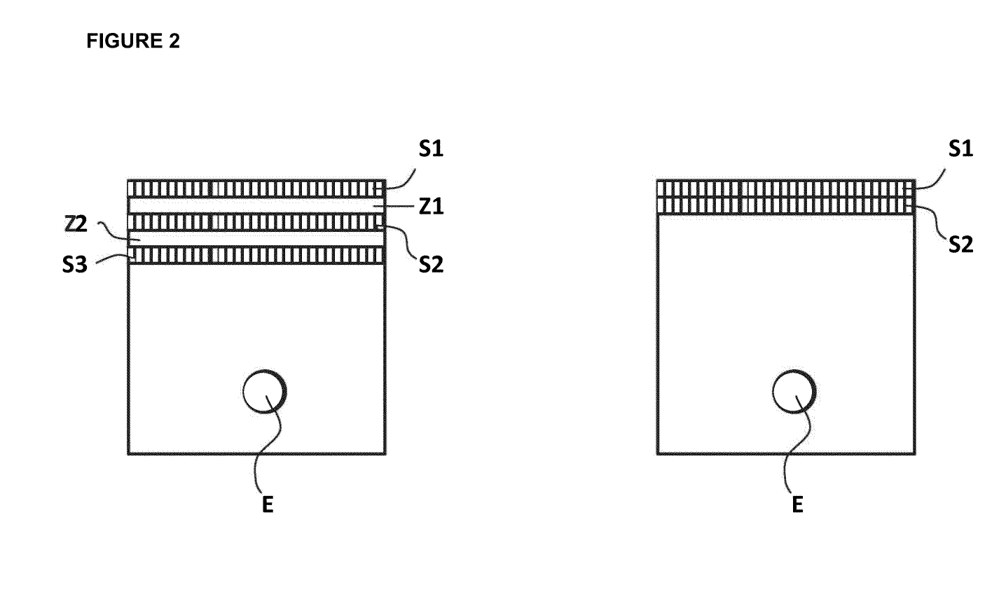

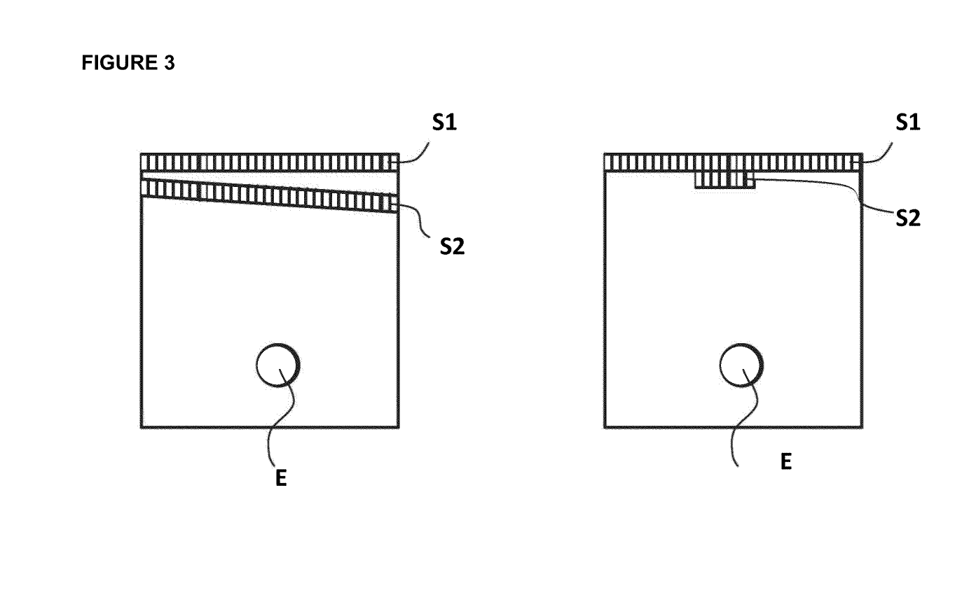

FIGS. 2 and 3 four further embodiments according to the invention of a vacuum cleaner filter bag according to the invention.

FIG. 4 a test piece of a vacuum cleaner filter bag according to the invention which is used for the test according to DIN 53 121, and also

FIG. 5 a prepared test piece of a vacuum cleaner filter bag according to the invention for determining the three-point bending strength Fₘₐₓ.

The filter bag according to the invention is equipped with spacing means which have the effect that the bag material—at least in essential regions—does not settle between appliance-side ribs. Several variants of these spacing means are possible:

1. Reinforcement of one or more weld seams present

Reinforcement of the weld seam is possible by the weld seam having a double configuration. In addition to the existing functional weld seam, i.e. which seals the bag, at least one further weld seam is introduced. This weld seam can likewise have a continuous configuration but an interrupted structure is also possible. If the second weld seam is configured parallel to the first weld seam, not overlapping, a bead-shaped structure is produced in the intermediate region between the two weld seams, which structure acts like a buffer band and hence as a spacing means.

In order to achieve optimum rigidity, it is possible to configure the weld seams, e.g. also as zigzag-shaped or undulating.

A previously described double or triple weld seam on the bag side orientated towards the grid of the motor protection filter reliably prevents the bag material from settling in front of the grid and forming a seal. The reinforcement of the other weld seams present can reliably prevent the bag material settling between ribs in the filter bag receiving space and impeding the outflow.

2. Rigid folds introduced in addition into the bag surface

It can happen that the regular weld seams, during insertion into the filter bag receiving space, do not come to settle such that a reinforcement can be achieved, that for example the outflow grid is kept free. In such cases, it is possible to dispose one or more projecting weld seams on the bag surface. It is thereby particularly advantageous to form one or more folds which are welded together.

3. Instead of a double weld seam, the spacing means can also be configured in the form of an additionally glued or welded strip made of plastic material.

FIG. 1 shows a first embodiment of a vacuum cleaner filter bag according to the invention which is configured in this case as a flat bag. Illustrated on the left in FIG. 1 is a plan view on the front-side of the vacuum cleaner filter bag in which the inlet opening E is also introduced. The rear-side of the vacuum cleaner filter bag thereby lies below the illustrated and visible front-side. Hence this flat bag consists of two layers of a nonwoven material which are welded to each other circumferentially at the edge-side. The vacuum cleaner filter bag according to the invention thereby has, on an edge side, a first, sealing weld seam S1, and also at a spacing relative to the weld seam S1, a further weld seam S2. The weld seam S2 thereby extends parallel to the weld seam S1 so that an intermediate region Z is configured between the two weld seams S1 and S2. The weld seams 51 and S2 can have for example respectively a width of 2.5 mm. Illustrated on the right in FIG. 1 is a section along the line A-B illustrated on the left in FIG. 1. The edge-side weld seam S1 and also the additional weld seam S2 disposed at a spacing herefrom can be seen. In the intermediate region Z, a bead-shaped bulge of the nonwoven material from which this flat bag is formed takes place. The individual nonwoven fabric layers from which the filter bag is formed thereby consist, for their part, of at least three layers, namely two scrim layers or nonwoven fabric layers 1 and 3, and also a fibre nonwoven fabric layer 2 which is disposed between these and is formed from loose fibres or filaments. On the outflow side, i.e. on the outside of the filter bag, additional further material layers, for example a meltblown layer and/or a further spun nonwoven fabric layer can be disposed. This embodiment is not illustrated merely for reasons of clarity.

In FIGS. 2 and 3, four further embodiments of vacuum cleaner filter bags according to the invention are illustrated.

Illustrated on the left in FIG. 2 is a further flat bag which has an edge-side weld seam S1, a first further weld seam S2 and also a further weld seam S3. Between the respective weld seams S1, S2 and S3, intermediate portions Z1 and Z2 are thereby configured, which are configured analogously to those illustrated on the right in FIG. 1.

FIG. 2 on the right shows a further embodiment according to the invention of a vacuum cleaner filter bag, two weld seams S1 and S2 being configured abutting directly against each other.

In FIG. 3 on the left, a variant in which the further weld seam S2 is disposed non-parallel, but angled (e.g. at an angle of 15°) relative to the weld seam S1 is shown.

FIG. 3 on the right shows an embodiment according to the invention in which the further weld seam S2 is not guided over the entire filter bag width. The length of the weld seam S2 here is for instance 30% of the length of the weld seam S1.

FIG. 4 shows the plan view on a test piece which is used to determine the rigidity according to the previously described method. The plan view illustrated in FIG. 4 corresponds to a plan view on an upright joint of two nonwoven fabric layers which is produced when looking onto the weld seam S1, as in the embodiment illustrated on the right in FIG. 1. The test piece illustrated in FIG. 4 is hence cut out of the edge region of the vacuum cleaner filter bag. The height of this test piece is thereby 60 mm, i.e. in the case of the example of FIG. 1, the length of the respective legs of the nonwoven material, measured from the lower end of the second weld seam S2 to each side, is 30 mm. The width is thereby chosen at 40-50 mm, varying this width within the indicated range does not thereby influence the resulting measurement result.

In order not to influence the measurement by the upright weld seam which includes the spacing means, the weld seam is fixed on a filter material layer before implementing a test. Such an embodiment is illustrated in FIG. 5. Again, the process hereby begins with the embodiment according to FIG. 1. It can be seen that an adhesive band K is used in order to fix the spacing means on a layer of the nonwoven material. The adhesive band K is thereby applied on the respective edge of a test piece. With reference to FIG. 3, the upright weld seam illustrated there is hence folded downwards and fixed respectively to the left and right at the edge of the test piece. Since the measurement is implemented in the centre of the test piece, the measurement result is consequently not influenced.

The present invention is explained in more detail in addition with the subsequent tests. The results are reproduced in Table 1.

TABLE 1

| | | | | Measured |
|---|---|---|---|---|
| | | Material construction | Description | bending |
| Test | Name | and description | weld seam | force [N] |
| 1* | Miele | Multilayer nonwoven | Functional | 0.93 |
| | HyClean GN | fabric bag, high | seam + | |
| | | grammage | “decorative | |
| | | | seam” | |
| 2* | Numatic | SMS | Functional | 0.24 |
| | NVM- | | seam + | |
| | 1CH 601415 | | “decorative | |
| | | | seam” | |
| 3* | HEPA- | SMS | Rotational | 0.24 |
| | STREAM | | seam | |
| 4* | s-bag ANTI- | SMS; side-gusseted bag, | Functional | 0.71 |
| | ODOUR | filter material lies in the | seam + | |
| | Electrolux | weld seam respectively | “decorative | |
| | | doubled (2x upper side + | seam” | |
| | | 2x lower side) | | |
| 5* | Flink & sauber | Multilayer nonwoven | Functional | 0.46 |
| | R010 | fabric bag | seam + | |
| | | | “decorative | |
| | | | seam” | |
| 6* | Vorwerk | Multilayer nonwoven | Functional | 1.1 |
| | FP140 | fabric bag, very high | seam + | |
| | | grammage | “decorative | |
| | | | seam” | |
| 7 | Sample 1 | Multilayer nonwoven | Two weld | 2.2 |
| | | fabric bag; side | seams, | |
| | | folds, filter | width of the | |
| | | material lies in the weld | seams | |
| | | seam respectively | respectively | |
| | | doubled (2x upper | approx | |
| | | side + 2x lower | 2.5 mm, | |
| | | side) | without | |
| | | | spacing | |
| | | | directly | |
| | | | adjacently | |
| 8 | Sample 2 | Multilayer nonwoven | Two weld | 2.9 |
| | | fabric bag; side | seams, | |
| | | folds, filter | width of the | |
| | | material lies in the weld | seams | |
| | | seam respectively | respectively | |
| | | doubled (2x upper | approx | |
| | | side + 2x lower | 2.5 mm, | |
| | | side) | spacing | |
| | | | approx. | |
| | | | 8 mm | |
| 9 | Sample 3 | Multilayer nonwoven | Two weld | 5.7 |
| | | fabric bag; side | seams, | |
| | | folds, filter | width of the | |
| | | material lies in the weld | seams | |
| | | seam respectively | respectively | |
| | | doubled (2x upper | approx. | |
| | | side + 2x lower | 2.5 mm, | |
| | | side) | spacing | |
| | | | approx. | |
| | | | 10 mm | |
| 10 | Sample 4 | Multilayer nonwoven | Two weld | 5.5 |
| | | fabric bag; side | seams, | |
| | | folds, filter | width of the | |
| | | material lies in the weld | seams | |
| | | seam respectively | respectively | |
| | | doubled (2x upper | approx. | |
| | | side + 2x lower | 2.5 mm, | |
| | | side) | spacing | |
| | | | approx. | |
| | | | 12 mm | |
| 11 | Sample 5 | Multilayer nonwoven | Two weld | 7.0 |
| | | fabric bag; side | seams, | |
| | | folds, filter | width of the | |
| | | material lies in the weld | seams | |
| | | seam respectively | respectively | |
| | | doubled (2x upper | approx. | |
| | | side + 2x lower | 2.5 mm, | |
| | | side) | spacing | |
| | | | approx. | |
| | | | 15 mm | |
| 12 | Sample 6 | Multilayer nonwoven | Two weld | 8.9 |
| | | fabric bag; side | seams, | |
| | | folds, filter | width of the | |
| | | material lies in the weld | seams | |
| | | seam respectively | respectively | |
| | | doubled (2x upper | approx. | |
| | | side + 2x lower | 2.5 mm, | |
| | | side) | spacing | |
| | | | approx. | |
| | | | 20 mm | |
| 13 | Sample 7 | Multilayer nonwoven | Two weld | 9.3 |
| | | fabric bag; side | seams, | |
| | | folds, filter | width of the | |
| | | material lies in the weld | seams | |
| | | seam respectively | respectively | |
| | | doubled (2x upper | approx. | |
| | | side + 2x lower | 2.5 mm, | |
| | | side) | spacing | |
| | | | approx. | |
| | | | 30 mm | |

*: not according to the invention

In order to illustrate the present invention, various, commercially available vacuum cleaner filter bags made of multilayer nonwoven materials or SMS materials were examined. All of the vacuum cleaner filter bags of the comparative tests 1* to 6* thereby have an edge-side weld seam. In addition, a decorative seam which has however no reinforcing function can also possibly be present. From the respective vacuum cleaner filter bags of tests 1* to 6*, test pieces, as illustrated in FIG. 3, were cut out and tested according to the indicated measurement method. The weld seam of the respective test pieces thereby extends in the centre of the test piece and, as illustrated in FIG. 4, is fixed on one side of the filter material. Determining the three-point bending strength Fₘₐₓ is indicated as measured path force in Newton. It is evident that all of the vacuum cleaner filter bags known from the state of the art and available as standard have a maximum three-point bending strength of 1.1 N (comparative test 6*). Such rigidities are however not sufficient to prevent the initially described problems that a corresponding vacuum cleaner filter bag abuts against the inlet opening during operation of the vacuum cleaner and hence partially blocks the latter.

The tests according to the invention are indicated by tests 7 to 13. Flat bags with side folds, the edge-side weld seam of which is modified on one side, are thereby used. The change or modification to the weld seam is indicated in the column “description weld seam”. In the case of the filter bags according to the invention according to tests 7 to 13, this weld seam has a double configuration instead of the single closing edge weld present. In the case of test 7, a second weld seam which, just as the standard sealing edge weld, is approx. 2.5 mm wide was applied directly next to the sealing edge weld without a spacing. Surprisingly, an increase in the three-point bending strength was in fact consequently able to be achieved. As a result, effective stiffening of the vacuum cleaner filter bag is effected in this region so that the double weld seam present can act as spacing element and, during operation of a vacuum cleaner filter bag which is inserted into a corresponding vacuum cleaner, the vacuum cleaner filter bag can be prevented from abutting against the suction opening of the motor space.

If the weld seam is disposed at a spacing relative to the closing weld seam (see tests 8 to 13, a respectively increasing spacing being present between the two weld seams of 8 mm to 30 mm), a further increase in the three-point bending strength achieved can be noted. As maximum, a force of 9.3 N could be measured with a spacing of the weld seams of 30 mm.

By means of the spacing means present according to the invention, effective stiffening of the side is hence effected, at which side for example doubling of the weld seam is provided, as a result of which the vacuum cleaner filter bag can be prevented from blocking the inflow opening of the motor space. Consequently, a pressure drop within the vacuum cleaner can be prevented and a longer lifespan of the vacuum cleaner filter bag can be achieved without the result thereby being a significant reduction in the total volume of the vacuum cleaner filter bag.

1. A vacuum cleaner filter bag made of nonwoven fabric, the nonwoven fabric having a joint which seals the bag at at least one edge of the vacuum cleaner filter bag and in which at least two layers of the nonwoven fabric are joined to each other,
the vacuum cleaner filter bag comprising, at least at one place of the edge, a spacing means which is formed by at least one further joint of the two layers of the nonwoven fabric being configured in a region for the joint which seals the bag or at least one reinforcing element being fixed on at least one of the two layers of the nonwoven fabric or between the two layers of nonwoven fabric,
wherein a three-point bending strength Fₘₐₓ of a test piece of the vacuum cleaner filter bag, measured according to DIN 53 121 with a path stretch of 7 mm, is at least 3.5 N.

2. The vacuum cleaner filter bag according to claim 1, wherein the three-point bending strength Fₘₐₓ of the test piece is at least 5 N.

3. The vacuum cleaner filter bag according to claim 1, wherein the vacuum cleaner filter bag
a) is a flat bag or side-gusseted bag and comprises a first layer of a nonwoven fabric which has an inlet opening, and also a second layer of an air-permeable nonwoven fabric, the two layers of the nonwoven fabric being joined to each other continuously at edge-side, so that the two layers of the nonwoven fabric form a sealed bag, or
b) is a 3D bag, a pleated vacuum cleaner filter bag or block bottom bag.

4. The vacuum cleaner filter bag according to claim 1, wherein the at least one further joint is configured at a spacing relative to the sealing joint or abutting directly against the sealing joint.

5. The vacuum cleaner filter bag according to claim 1, wherein the at least one further joint is disposed parallel or non-parallel to the sealing joint.

6. The vacuum cleaner filter bag according to claim 1, wherein the at least one further joint has a smaller length than the sealing joint.

7. The vacuum cleaner filter bag according to claim 1, wherein the at least one further joint extends at a spacing of 1 to 50 mm relative to the sealing joint.

8. The vacuum cleaner filter bag according to claim 1, comprising a spacer that comprises, in addition to the sealing joint at least two further joints of the two layers of the nonwoven fabric in the region for the sealing joint.

9. The vacuum cleaner filter bag according to claim 8, wherein the at least two further joints are
positioned at a spacing relative to each other and at a spacing relative to the sealing joint
a first of the at least two further joints abutting directly against the sealing joint and the at least one further of the at least two further joints at a spacing respectively relative to each other,
or the at least two further joints abut against each other and relative to the sealing joint.

10. The vacuum cleaner filter bag according to claim 9, wherein the spacing of the at least two further joints relative to each other or the spacing of the first of the at least two further joints relative to the sealing joint (S1) is, independently of each other, from 1 to 50 mm.

11. The vacuum cleaner filter bag according to claim 1, wherein independently of each other, the sealing joint or the at least one further joint has a width of 1 to 50 mm.

12. The vacuum cleaner filter bag according to claim 1, wherein the at least one further joint is continuous over its length.

13. The vacuum cleaner filter bag according to claim 1, wherein the at least one further joint extends parallel to the sealing joint.

14. The vacuum cleaner filter bag according to claim 1, wherein the region of the two layers of the nonwoven fabric, which is configured between the sealing joint and the at least one further joint disposed at a spacing relative thereto or the at least one further joint disposed between respectively at least two, at a spacing relative to each other, is not joined or has joints of the two layers of nonwoven fabric only in regions.

15. The vacuum cleaner filter bag according to claim 14, wherein joints of the two layers of nonwoven fabric are present only in regions, the joints having an oblong configuration and extending perpendicular to the sealing joint or to the at least one further joint or having a punctiform configuration.

16. The vacuum cleaner filter bag according to claim 1, wherein, in projection of the first towards the second layer of the nonwoven fabric, a contour of the vacuum cleaner filter bag has a polygonal configuration and a spacer extends continuously over at least one side of the polygon.

17. The vacuum cleaner filter bag according to claim 1 wherein a spacer is postioned in the region of a suction opening of the motor fan unit of a vacuum cleaner which is suitable for the vacuum cleaner filter bag.

18. The vacuum cleaner filter bag according to claim 1, wherein on the first or second layer of the nonwoven fabric, at least one additional spacer is configured, which is formed by joining, in places, regions of the respective layer of the nonwoven fabric which are folded one above the other.

19. The vacuum cleaner filter bag according to claim 1, wherein the sealing joint or the at least one further joint is produced by welding or by glueing together the two layers of the nonwoven fabric.

20. The vacuum cleaner filter bag according to claim 1, wherein the three-point bending strength Fₘₐₓ of the test piece is at least 8 N.
